(19) United States
(12) Patent Application Publication
(10) Pub. No.: US 2016/0201595 A1
(43) Pub. Date: Jul. 14, 2016

(54) Crankcase Ventilation System Geometry Optimization

(71) Applicant: Caterpillar Inc., Peoria, IL (US)

(72) Inventors: Joshua Hyde, West Lafayette, IN (US); Rodney Lawrence, Frankfort, IN (US); Brandyn Stack, Lafayette, IN (US)

(73) Assignee: Caterpillar Inc., Peoria, IL (US)

(21) Appl. No.: 14/594,643

(22) Filed: Jan. 12, 2015

(51) Int. Cl. F02F 1/24; F02F 7/00

(52) U.S. Cl. CPC F02F 1/24; F02F 7/0002

(57) ABSTRACT

An internal combustion engine having an oil drain opening connected to an oil drain passage in a cylinder head for simultaneously providing flow of oil to a crankcase and blow-by gases to a crankcase ventilation whereby the geometry of the oil drain opening and oil drain passage are such that the velocity of blow-by gas flow through the oil drain opening is limited.

### TECHNICAL FIELD

The present disclosure relates generally to the field of combustion engines, and more particularly, to a crankcase ventilation system for use in connection with such combustion engines which lessen the amount of oil entrained in the combustion blow-by gases that are pulled into the crankcase ventilation system.

### BACKGROUND

Internal combustion engines generally consist of a bank of cylinders where the combustion of a fuel/air mixture takes place. The cylinders generally act as a sleeve for housing the piston for reciprocating movement caused by fuel/air combustion in the cylinder. This reciprocating movement is then translated into rotational movement of a crankshaft through the use of connecting rods that are pivotally attached on one end to the bottom of the piston and pivotally attached on the other end to the crankshaft.

The movement of all of these attached parts can create a tremendous amount of heat and friction which needs to be dissipated. Accordingly, it is common to encase the crankshaft and the bottom of the piston assemblies with a crankcase, the crankcase providing an enclosed area for the circulation of engine oil to parts of the crankshaft, the walls of the cylinders, the valves, rockers, etc.

It has been found that most internal combustion engines, particularly larger ones, require a crankcase ventilation system comprised of a one way pasage for release of gases from the crankcase. The crankcase ventilation system is provided to allow gases to escape the crankcase in a controlled manner because internal combustion inevitably involves a small but continual amount of blow-by, namely the leaking of combustion gases from the combustion chamber past the piston rings, turbo seals, valve stem seals, etc. Accordingly, for control of the pressure inside the crankcase, it is generally known to provide a crankcase ventilation system.

It is further known to provide the cylinder head with an oil return passage for returning oil from the cylinder head back to the oil sump through a drain-back opening. This passage needs to be in fluid communication with the crankcase ventilation system, in order to allow blow-by gases to be released from the crankcase. Further, this passage needs to be connected to the oil sump, to allow the oil to properly drain back to the oil sump for recirculation. However, the use of this passage for both oil and gas circulation can create some issues.

Specifically, the blow-by gas flow can be at a relatively high flow rate. Given the tight restrictions in the oil drain back passage and the high velocity of blow-by gases, oil can become undesirably entrained in the gas and pulled into the crankcase ventilation system. Such a system is undesirable as it can result in fouling of the system. Another shortcoming is that oil foaming can occur from the blow-by gases flowing past the draining oil. In addition to fouling the equipment, these problems can also contribute to oil oxidation and contamination, which can be detrimental to engine life.

There have been prior attempts to resolve issues related to this problem. For example, Pub. No. US 2009/0314230 A1 to Nagenkogl et al. entitled Crankcase Breathing System discloses the use of a preliminary separator arranged integrally with a main separator wherein the main separator is formed by a cyclone separator with the outlet of the preliminary separator being arranged in a tangential way relative to the main separator. Additionally, the Nagenkogl reference discloses the use of at least one baffle plate in the preliminary separator between the inlet and the outlet of the preliminary separator wherein the baffle plate is spaced from the outlet of the preliminary separator.

While the system disclosed in the Nagenkogl reference may be useful in removing some entrained oil from the blow-by gases, there is still desired a crankcase ventilation system that utilizes an improved and/or optimized geometry to reduce oil entrainment in blow-by combustion gases.

### SUMMARY

According to the present disclosure, an internal combustion engine having an improved crankcase ventilation system is provded. More specifically, a cylinder block having at least one cylinder therein for housing a reciprocating piston, a crankshaft operably connected to the piston, the crankshaft being located in a crankcase, the crankcase further including an oil sump is disclosed. In accordance therewith a cylinder head may be attached to the cylinder block and may have at least a portion of a crankcase ventilation system attached thereto. The cylinder head my have an oil drain opening therein, the oil drain opening connecting to an oil drain passage providing for the return of oil to the oil sump and the escape of gases into the crankcase ventilation system. In accordance with the disclosure, the oil drain opening may be shaped such that velocity of blow-by gas flow through the drain opening may be controlled such that entrained oil caught therein is limited. Further, the oil drain passage may provide a volume such that velocity of the blow-by gas through the drain opening is limited.

### BRIEF DESCRIPTION OF THE DRAWINGS

FIG. 1 is a side perspective view of portions of a combustion engine in accordance with aspects of the disclosure;

FIG. 2 is a top perspective view of a cylinder head of the combustion engine of FIG. 1 in accordance with aspects of the disclosure;

FIG. 3 is a side perspective view of interior portions and passages, including an oil drain passage, of the combustion engine of FIG. 1 in accordance with aspects of the disclosure;

FIG. 4 is a detailed view of an oil drain opening located in the cylinder head of FIG. 2 in accordance with one embodiment of the present disclosure;

FIG. 5 is a detailed view of an oil drain opening located in the cylinder head of FIG. 2 in accordance with an alternate embodiment of the present disclosure; and

FIG. 6 is a view of a sectional portion of the oil drain passage located in the cylinder head shown in FIG. 3 taken along line 6-6.

### DETAILED DESCRIPTION

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

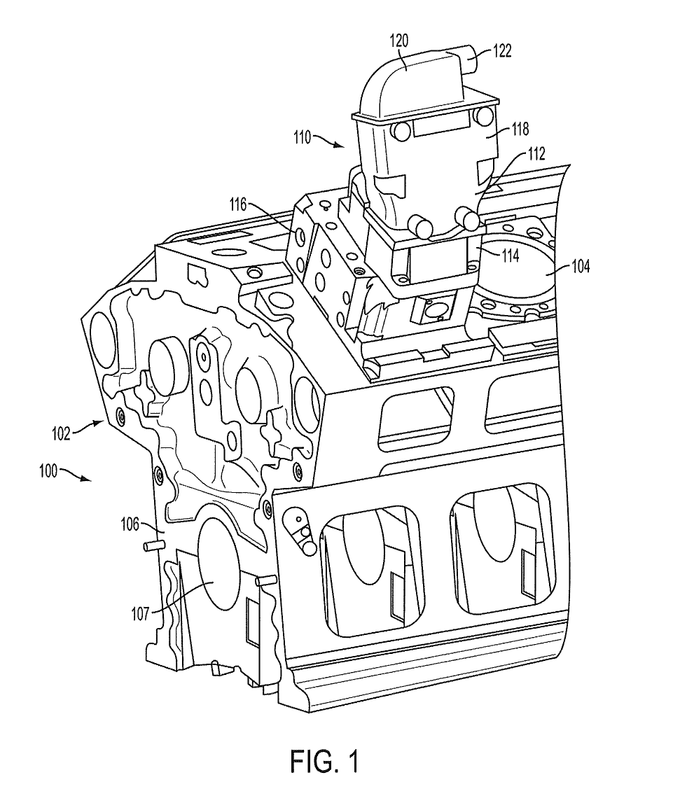

FIG. 1 shows an internal combustion engine 100, such as, a compression ignition engine. Alternatively, engine 100 may be a spark ignition engine or a natural gas engine of any size, with any number of cylinders, and in any configuration (“V,” in-line, radial, etc.>. Further, the internal combustion engine 100 may operate using a variety of fuels, for example, but not limited to, gasoline, diesel, methane, propane, or any other fuels known in the art. Additionally, it is known in the art to run combinatinos of fuels, for example, the use of diesel and pipeline gases simultaneously. The internal combustion engine 100 may include a cylinder block 102 that at least partially defines at least one cylinder 104 housing a reciprocating piston (not shown). The internal combustion engine 100 may further include a crankshaft (not shown) operably coupled to the pistons, such that reciprocation of the pistons within the cylinders 104 serves to rotate the crankshaft. The crankshaft may be housed within a crankcase 106 constituting a lower portion of the cylinder block 102 and an oil sump (not shown). The crankcase 106 may have a crankshaft bore 107 therethrough and be adequately sealed from the surrounding atmosphere to prevent vapor from the engine 100 being expelled directly into the atmosphere.

According to an exemplary embodiment of the present disclosure, a crankcase ventilation system 110 for allowing blow-by engine gases to be filtered and properly vented may be integrated as part of the valve cover assembly 112 or may be provided as a separate unit (not shown). The crankcase ventilation system 110 may be used to relieve the pressure in the crankcase 106 caused by blow-by gases and may also act to filter and return some entrained particulates, such as entrained oil, therefrom to return to the crankcase 106. The entrained oil may come from oil dripping back to the sump from the crankcase ventilation system 110 and may also comprise oil that is being used to lubricate various portions of the rocker mechanisms and/or valve mechanisms (not shown). The rocker mechanisms/valve mechanisms may be housed in the rocker box 114 and may be attached to the cylinder head 116. The valve cover assembly 112 may be attached to the rocker box 114. In accordance with embodiments of the disclosure, some cylinder heads 116 may have standard valve cover assemblies attached thereto (not shown) while others may include valve cover assemblies 112 including crankcase ventilation systems 110 attached thereto (depending on the amont of crankcase ventilation required by the specific application).

In accordance with the disclosure, the crankcase ventilation system 110 may include an integrated breather 118. The integrated breather 118 may comprise a pre-separator for helping to remove entrained oil from the blow-by gases and, as such may include an oil condensing mesh, a foil pack, and/or other known condensation aids packed therein. The integrated breather 118 may have an outlet cover 120 having a vapor outlet 122 for directing blow-by gases to a central filtration mechanism (not shown) or otherwise out of the engine 100.

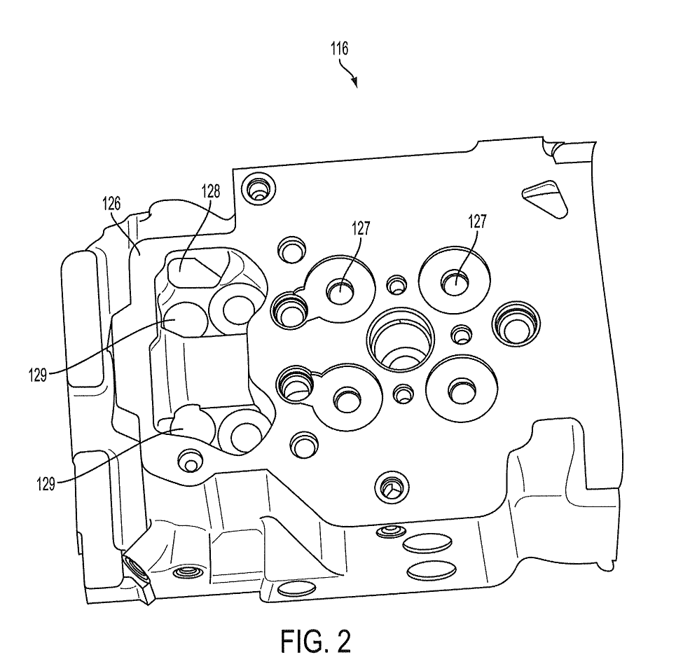

As best shown in FIG. 2, the top deck 126 of the cylinder head 116 may comprise a housing for portions of the engine 100 as is known in the art including, for example, valve spring housings 127, pushrod housings 129, etc. In order to allow blow-by gases to be ventilated from the crankcase 106 by the crank case ventilation system 110, as well as to allow oil to drain back to the sump, an oil drain opening 128 may be provided in the cylinder head 116. Oil drain opening 28 comprises an opening that leads from the cylinder head 116 through the cylinder block 102 down to the sump to allow oil to drain to the sump while simultaneously providing an opening for blow-by gases up into the rocker box 114 and threafter into the crankcase ventilation system 110.

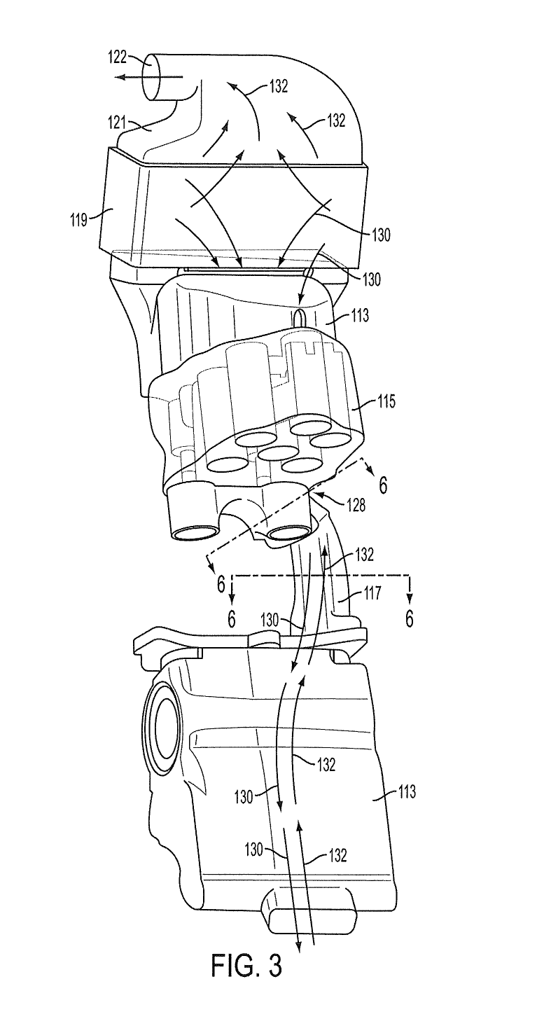

In accordance with the foregoing, FIG. 3 depicts the simultaneous flow 130 of oil downward to the sump through the same openings that blow-by gases flow up 132 to and through the crankcase ventilation system 110. More specifically, FIG. 3 depicts the interior portions of the cylinder block 102, cylinder head 116, rocker box 114, valve cover assembly 112, integrated breather 118 and outlet cover 120. Accordingly, it can be seen that while blow-by gases are flowing up 132 through the interior 103 of the cylinder block 102 (namely, the cam gallery), through the oil drain passage 117 of the cylinder head 116, through the oil drain opening 128, into the interior 115 of the rocker box 114, up through the interior 113 of the valve cover assembly 112, into the interior 119 of the integrated breather 118, through the interior 121 of the outlet cover 120, and finally out the vapor outlet 122, oil is simultaneously flowing 130 downward through those same passages. As such, it can be readily understood how oil can easily become entrained in the blow-by gases in these passages and carried up into the interior 119 of the integrated breather 118 causing undesirable fouling of the condensation medium therein and/or fouling of the central filtration mechanism (not shown).

In accordance with aspects of the disclosure, it has been found that the oil drain opening 128 located in the cylinder head 116, and more particularly, the specific geometry of that opening 128, as well as the cross-sectional area of oil drain passage 117 just below the opening 128 may critically effect the amount of that oil becomes undesirably entrained in the blow-by gases. More specifically, it has been determined that if the specific velocity of the blow-by gases can be kept below approximately 1200 mm/s as they travel thourgh the oil drain opening 128 at typical operating flow rates from the crankcase 106, that the amount of oil entrained in the blow-by gases may be maintained at an acceptable level.

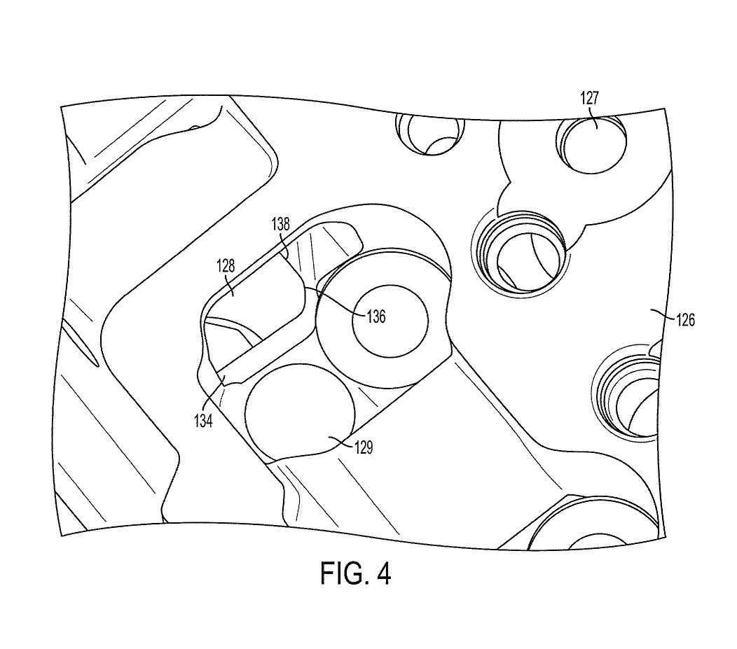

In accordance therewith with respect to the opening 128 geometry, FIG. 4 provides a detailed depiction of one exemplary embodiment of an oil drain opening 128. In this embodiment, the opening 128 is defined by a rounded anterior edge 134 located proximal the pushrod housing 129 and includes a shoulder portion 136 leading to a generally perpendicular lateral edge 138. It has been determined, that in this embodiment (including cross-sectional areas of the oil drain passage 117 set forth below), at an operating flow rate of blow-by gases from the crankcase 106 of 27 cfm, the specific velocity predicted at opening 128 having this geometry would be approximately 11300 mm/s Additionally, for this embodiment, it has been determined that at an operating flow rate of 24 cfm from the crankcase 106, the specific velocity predicted at opening 128 would be approximately 9000 mm/s

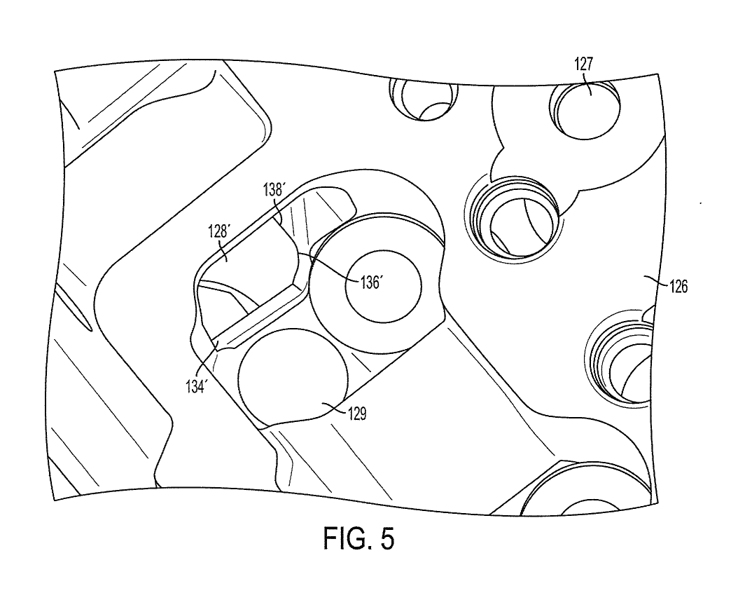

Similarly, FIG. 5 provides a detailed depiction of an alternate exemplary embodiment of oil drain opening 128′. In accordance with this embodiment, opening 128′ is defined by a downwardly chamfered anterior edge 134′ located proximal the pushrod housing 129 and includes a shoulder portion 136′ leading to a generally perpendicular lateral edge 138′. For this embodiment (including cross-sectional areas of the oil drain passage 117 set forth below), it has been determined that at an operating flow rate of blow-by gases from the crankcase 106 of 27 cfm, the specific velocity predicted at opening 128′ having this geometry is approximately 10500 mm/s. Additionally, for this embodiment, it has been determined that at an operating flow rate of 24 cfm from the crankcase 106, the specific velocity predicted at opening 128′ is approximately 9300 mm/s.

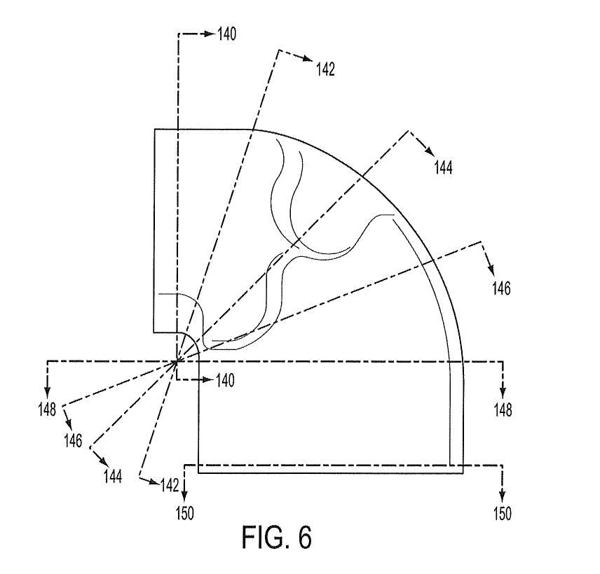

As best shown in FIG. 6, it has been determined that the geometry of the oil drain passage 117 located just below opening 128, 128′ can significantly effect the specific velocities predicted at opening 128 and 128′ respectively. More specifically, it has been determined that prior cross-sectional areas of approximately 1600 mm² taken at 140 (90 degree position below opening 128, 128′), 1650 mm² taken at 142 (70 degree position), 1800 mm² taken at 144 (42.5 degree position), 1800 mm² taken at 146 (20 degree position), 1700 mm² taken at 148 (approximately 90 mm above the cylinder block 102) and 1700 mm² taken at 150 (approximately 75 mm above the cylinder block 102) may contribute to undesirably high velocities predicted at opening 128, 128′.

In response thereto, higher cross-sectional areas in this section of oil drain passage 117 have been determined to decrease predicted velocities of the blow-by gases to a more acceptable level at opening 128, 128′. More specifically, it has been determined that cross-sectional areas of approximately 1700 mm² (or greater) taken at 140, 1800 mm² (or greater) taken at 142, 1800 mm² (or greater) taken at 144, 2100 mm² (or greater) taken at 146 (20 degree position), 2100 mm² (or greater) taken at 148, and 2200 mm² taken at 150 may contribute significantly to desired predicted velocities at opening 128, 128′. Even more specifically, it has been determined that cross-sectional areas of approximately 1800 mm² (or greater) taken at 140, 1900 mm² (or greater) taken at 142, 1800 mm² (or greater) taken at 144, 2300 mm² (or greater) taken at 146 (20 degree position), 2500 mm² (or greater) taken at 148, and 2600 mm² taken at 150 may contribute even more significantly to desired predicted velocities at opening 128, 128′.

As will be understood to those of ordinary skill in the art, increases in volume in the oil drain passage 117 discussed herein will decrease velocities at opening 128, 128′. In accordance therewith, changes to the discussed specific area measurements disclosed herein may be made while still generally increasing the volume of the oil drain passage 117 without departing from the scope of the present disclosure.

### INDUSTRIAL APPLICABILITY

The industrial applicability of the crankcase ventilation system geometry disclosed herein will be readily appreciated from the foregoing discussion. Specifically, referring to the figures in general, in operation, the crankcase ventilation system 110 may be used to allow blow- by gases to be vented from the cylinder block while simultaneously operating to segregate the oil particles from exhaust of the crankcase 106. More specifically, the geometry of the oil drain opening 128 and oil drain passage 117 disclosed herein may allow for the flow of oil downward therethrough into the crankcase 106 while simultaneously allowing blow-by gases to enter into the crankcase ventilation system 110 at a velocity through the opening 128 such that an undesirable amount of oil does not become entrained in the blow-by gases. In accordance with the disclosure, the geometry optimization may provide a cost-effective method for preventing fouling of the interior 119 of the integrated breather 118, and more specifically, the condensation materials packed therein.

More generally, in accordance with the foregoing, the present disclosure operates to allow blow-by gases to be released from the crankcase 106 while simultaneously allowing oil, including entrained oil, to drip back to the oil sump. In accordance with the optimized geometry provided herein, the amount of entrained oil being carried up to the integrated breather 118 and/or out through the vapor outlet 122 may be signficiantly reduced.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

We claim:

1. An internal combustion engine comprising:
a cylinder block having at least one cylinder therein for housing a reciprocating piston;
a crankshaft operably connected to the piston, the crankshaft being located in a crankcase, the crankcase further including an oil sump;
a cylinder head attached to the cylinder block and having at least a portion of a crankcase ventilation system attached thereto, the cylinder head having an oil drain opening therein, the oil drain opening connected to an oil drain passage for providing the return of oil to the oil sump and the escape of gases into the crankcase ventilation system;
wherein the oil drain opening comprises at least one anterior edge and one lateral edge, the anterior edge having a generally rounded profile.

2. The internal combustion engine of claim 1 wherein the specific velocity of gas flow through the oil drain opening is less than 12000 mm/s when gases flow from the crankcase at or below 27 cfm.

3. The internal combustion engine of claim 1 wherein the specific velocity of gas flow through the oil drain opening is less than 1000 mm/s when gases flow from the crankcase at or below 24 cfm.

4. The internal combustion engine of claim 1 wherein the oil drain passage is connected to the cylinder block.

5. The internal combustion engine of claim 4 wherein a cross-sectional area of the oil drain passage at a location approximately 75 mm from the engine block is at least 2200 mm².

6. The internal combustion engine of claim 4 wherein a cross-sectional area of the oil drain passage at a location approximately 75 mm from the engine block is at least 2600 mm².

7. The internal combustion engine of claim 4 wherein a cross-sectional area of the oil drain passage at a location approximately 90 mm from the engine block is at least 2200 mm².

8. The internal combustion engine of claim 4 wherein a cross-sectional area of the oil drain passage at a location approximately 90 mm from the engine block is at least 2600 mm².

9. An internal combustion engine comprising:
a cylinder block having at least one cylinder therein for housing a reciprocating piston;
a crankshaft operably connected to the piston, the crankshaft being located in a crankcase, the crankcase further including an oil sump;
a cylinder head attached to the cylinder block and having at least a portion of a crankcase ventilation system attached thereto and having an oil drain opening therein, the oil drain opening connected to an oil drain passage for providing the return of oil to the oil sump and the escape of gases into the crankcase ventilation system;
wherein the oil drain opening comprises at least one anterior edge and one lateral edge, the anterior edge having a generally downwardly chamfered profile.

10. The internal combustion engine of claim 9 wherein the specific velocity of gas flow through the oil drain opening is less than 12000 mm/s when gases flow from the crankcase at or below 27 cfm.

11. The internal combustion engine of claim 9 wherein the specific velocity of gas flow through the oil drain opening is less than 1000 mm/s when gases flow from the crankcase at or below 24 cfm.

12. The internal combustion engine of claim 9 wherein the oil drain passage is connected to the cylinder block.

13. The internal combustion engine of claim 12 wherein a cross-sectional area of the oil drain passage at a location approximately 75 mm from the engine block is at least 2200 mm².

14. The internal combustion engine of claim 12 wherein a cross-sectional area of the oil drain passage at a location approximately 75 mm from the engine block is at least 2600 mm².

15. The internal combustion engine of claim 12 wherein a cross-sectional area of the oil drain passage at a location approximately 90 mm from the engine block is at least 2200 mm².

16. The internal combustion engine of claim 12 wherein a cross-sectional area of the oil drain passage at a location approximately 90 mm from the engine block is at least 2600 mm².

17. An internal combustion engine comprising:
a cylinder block having at least one cylinder therein for housing a reciprocating piston;
a crankshaft operably connected to the piston, the crankshaft being located in a crankcase, the crankcase further including an oil sump;
a cylinder head attached to the cylinder block and having at least a portion of a crankcase ventilation system attached thereto and having an oil drain opening therein, the oil drain opening connected to an oil drain passage for providing the return of oil to the oil sump and the escape of gases into the crankcase ventilation system;
wherein the specific velocity of gas flow through the oil drain opening is less than 12000 mm/s when gases flow from the crankcase at or below 27 cfm.

18. The internal combustion engine of claim 17 wherein the oil drain passage is connected to the cylinder block.

19. The internal combustion engine of claim 18 wherein a cross-sectional area of the oil drain passage at a location approximately 75 mm from the engine block is at least 2200 mm².

20. The internal combustion engine of claim 18 wherein a cross-sectional area of the oil drain passage at a location approximately 90 mm from the engine block is at least 2200 mm².
